(19) United States
(12) Patent Application Publication
(10) Pub. No.: US 2017/0337275 A1
(43) Pub. Date: Nov. 23, 2017

(54) ALLOCATING COMPUTING RESOURCES

(71) Applicant: International Business Machines Corporation, Armonk, NY (US)

(72) Inventors: Venkatesh K. S. Babu, Bangalore (IN); Apoorv Kapse, Bangalore (IN); Gaurav Saxena, Bangalore (IN); Muralidhar V. K. Vanapalli, Bengaluru (IN)

(21) Appl. No.: 15/156,656

(22) Filed: May 17, 2016

(51) Int. Cl. G06F 17/30; H04L 12/911; H04L 29/08

(52) U.S. Cl. CPC G06F 17/30864; H04L 67/1002; G06F 17/30896; H04L 47/783

(57) ABSTRACT

A computer-implemented method includes generating a query. The query is directed to a database server. The database server allocating a predetermined quantity of computing resources to the query. The method includes identifying a speed threshold. The method includes determining a quantity of running resources. The quantity of running resources is effective for a running speed for the query to exceed the speed threshold. The method is responsive to the quantity of running resources being greater than the predetermined quantity of computing resources. The method includes including an option with the query. The option is for additional computing resources to be allocated to the query. The method is responsive to input selecting the option, by transmitting the query and the additional computing resources to the database server.

### BACKGROUND

The present invention relates generally to the field of database query processing, and more particularly to allocating computing resources in cloud environments.

A query is a declarative statement that may be processed to retrieve data within a database management system. Queries allow user to describe what information they want retrieved, from where they want the information retrieved, and other information that affects, the performance of desired operations. Particular queries may require computing resources to be processed efficiently. Computing resources may be an amount of memory space or an amount of storage. Storage may be within the database managing the query or accessible remotely, such as via a cloud environment.

### SUMMARY

A computer-implemented method includes generating a query. The query is directed to a database server. The database server allocating a predetermined quantity of computing resources to the query. The method includes identifying a speed threshold. The method includes determining a quantity of running resources. The quantity of running resources is effective for a running speed for the query to exceed the speed threshold. The method is responsive to the quantity of running resources being greater than the predetermined quantity of computing resources. The method includes including an option with the query. The option is for additional computing resources to be allocated to the query. The method is responsive to input selecting the option, by transmitting the query and the additional computing resources to the database server. A corresponding computer program product and computer system are also disclosed.

In an aspect, a computer-implemented method includes receiving, from an application server, a query. The method includes allocating a predetermined quantity of computing resources to the query. The method includes receiving, from the application server, a request to allocate additional computing resources to the query. The method includes selectively allocating the additional computing resources to the query based on an option selection notification. The option selection notification is from the application server. The method includes processing the query.

### BRIEF DESCRIPTION OF THE DRAWINGS

FIG. 1 is a block diagram of an operational environment suitable for operation of a resource allocation program via a database server, in accordance with at least one embodiment of the present invention.

FIG. 2 is a block diagram of an application server operational environment suitable for operation of a resource allocation program via an application server, in accordance with at least one embodiment of the present invention.

FIG. 3 is a flowchart depicting operational steps for a resource allocation program via a database server, in accordance with at least one embodiment of the present invention.

FIG. 4 is a flowchart depicting operational steps for a resource allocation program via an application server, in accordance with at least one embodiment of the present invention.

FIG. 5 is a block diagram of components of an operational apparatus suitable for executing a resource allocation program, in accordance with at least one embodiment of the present invention.

FIG. 6 depicts a cloud computing environment according to an embodiment of the present invention.

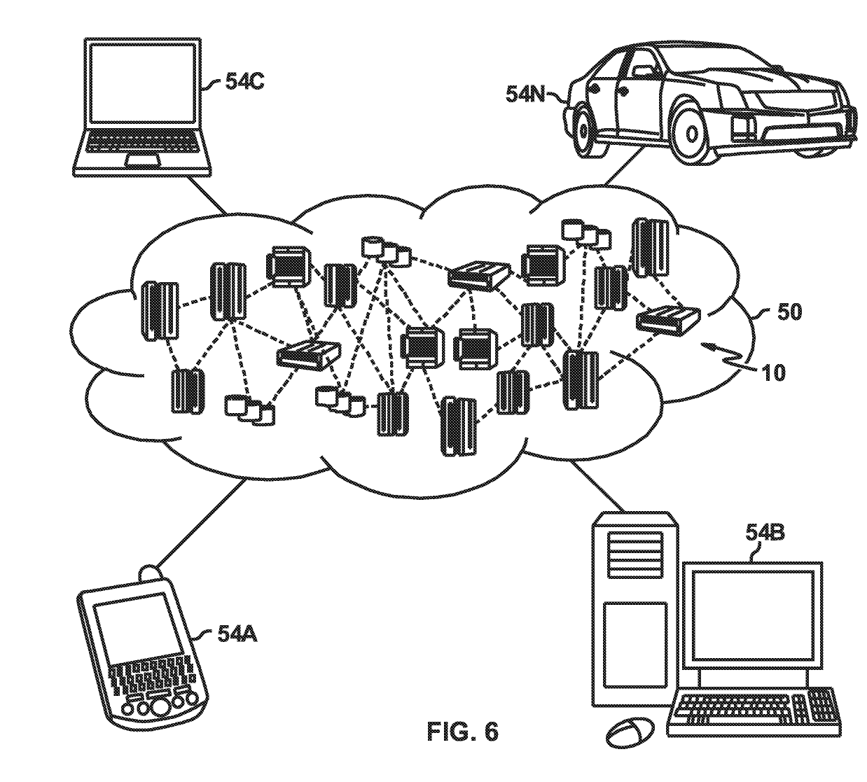

FIG. 7 depicts abstraction model layers according to an embodiment of the present invention.

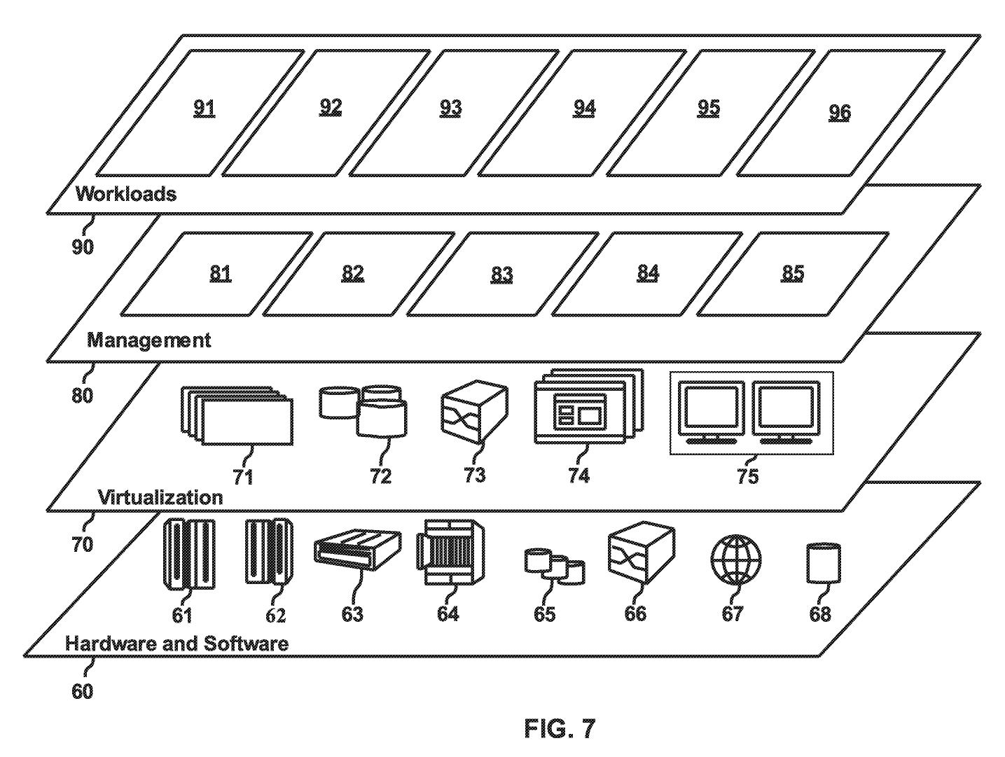

### DETAILED DESCRIPTION

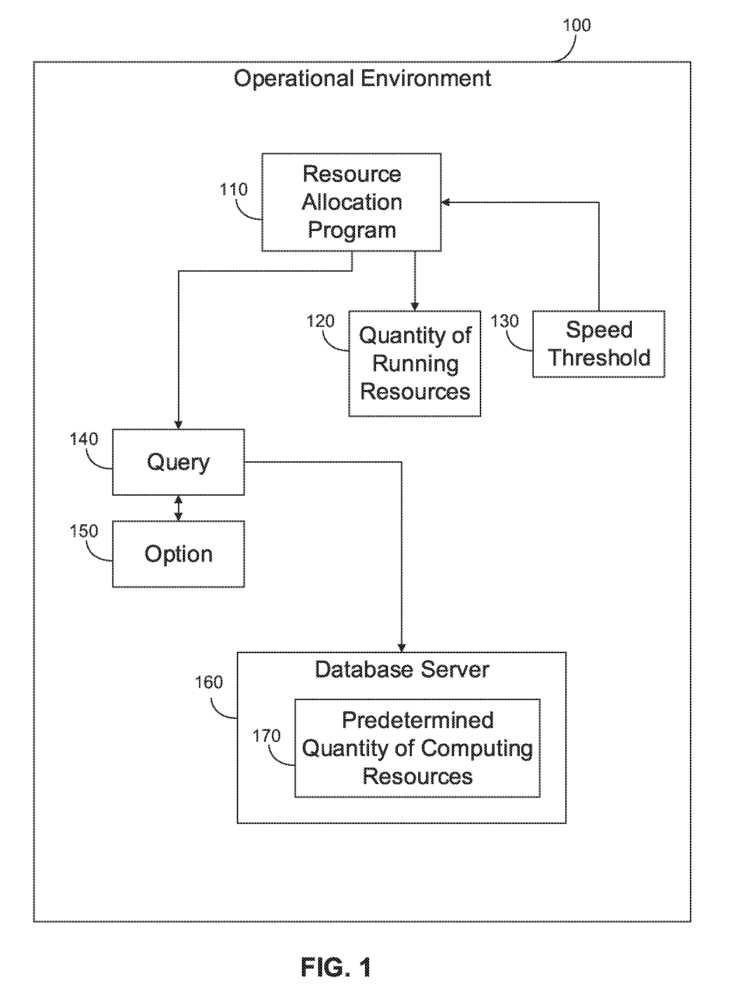

Referring now to the invention in more detail, FIG. 1 is a block diagram displaying an exemplary operational environment suitable for operation of at least one embodiment of the invention. An operational environment 100 includes a resource allocation program 110, a quantity of running resources 120, a speed threshold 130, a query 140, an option 150, and a database server 160, which includes a predetermined quantity of computing resources 170, all in mutual communication and interconnected via the operational environment 100. The operational environment 100 may be a cloud-based, virtual, or distributed environment or a remote environment on defined server hardware, or, more generally, the operational environment 100 may be any type of environment suitable for access by the resource allocation program 110.

In an embodiment, the query 140 is a step or set of ordered steps used to access data in a structured query language relational database management system. The query 140 may be directed towards the database server 160. The resource allocation program 110 may generate the query 140.

In an embodiment, the database server 160 is a computer program that provides database services to other computer programs or computers, as defined by a client-server model. The database server 160 may receive queries, such as the query 140, from the resource allocation program 110. In some embodiments, the database server 160 includes the predetermined quantity of computing resources 170. The predetermined quantity of computing resources 170 are an amount of computing resources. A computing resources may be understood as a resources used to complete a computational process. The computational resource may be memory space or an amount of storage space. The computational resources may be available to the database server 160 via a cloud environment. For example, the computational resource may be memory space that is available via a cloud environment.

In some embodiments, the cloud environment is a platform as a service. A platform as a service is a cloud computing model that delivers applications over the internet. In a platform as a service model, a cloud provider delivers hardware and software tools to its users as a service. A platform as a service provider may host the hardware and software on its own infrastructure. The predetermined quantity of computing resources 170 may be predetermined by a user and/or computer programmer. The predetermined quantity of computing resources 170 is an amount of computing resources that the database server 160 allocates to the query 140. The predetermined quantity of computing resources 170 may be a fixed amount. For example, the predetermined quantity of computing resources 170 may be a particular amount of computing resources that the database server 160 allocates to every query. The predetermined quantity of computing resources 170 may be based on a size associated with the query 140. For example, the database server 160 may allocate more resources to a query with more steps. The predetermined quantity of computing resources 170 may be a minimum amount of computing resources for queries to be processed at an average minimum processing time.

The speed threshold 130 may be an amount of time. The speed threshold 130 may be a predetermined amount of time. In other embodiments, the speed threshold 130 is a rate of operations per time. For example, how many steps of a query are processed in a particular timespan. In such an example, the speed threshold 130 may be one step per second. The query 140 is associated with a running speed. The running speed may be an amount of time. In other embodiments, the running speed is a rate of operations per time. In general, the running speed and speed threshold 130 are directly comparable. That is, in embodiments where the speed threshold 130 is an amount of time, the running speed is also an amount of time. In embodiments where the speed threshold 130 is a rate of operations per time, the running speed is also a rate of operations per time. The running speed associated with the query 140 may increase or decrease depending on the quantity of computing resources the database server 160 allocates to the query 140. The resource allocation program 110 determines the quantity of running resources 120, which are a quantity of resources that the query 140 would need such that its running speed is greater than or equal to the speed threshold 130.

The resource allocation program 110 may include the option 150 with the query 140. The option 150 may be a query expressed in a structured query language statement prompting a user for input. The option 150 may be included in the query text. In such an embodiment, the option 150 may be a flag, prompt, or other notification such that the option 150 is displayed to a user. The resource allocation program 110 may include the option 150 with the query 140 and only begin to process the query responsive to user input either selecting or rejecting the option 150. In some embodiments, the flag may be coded as an option in the query itself, as part of a login process of the database server 160, or in an underlying communication such as an HTTP request that includes the query. The database server 160 may be configured to check for flags in the HTTP request, login procedure, or query string and responsively consider the request for additional resources. The option 150 may also include a parameter for how much additional resources are needed.

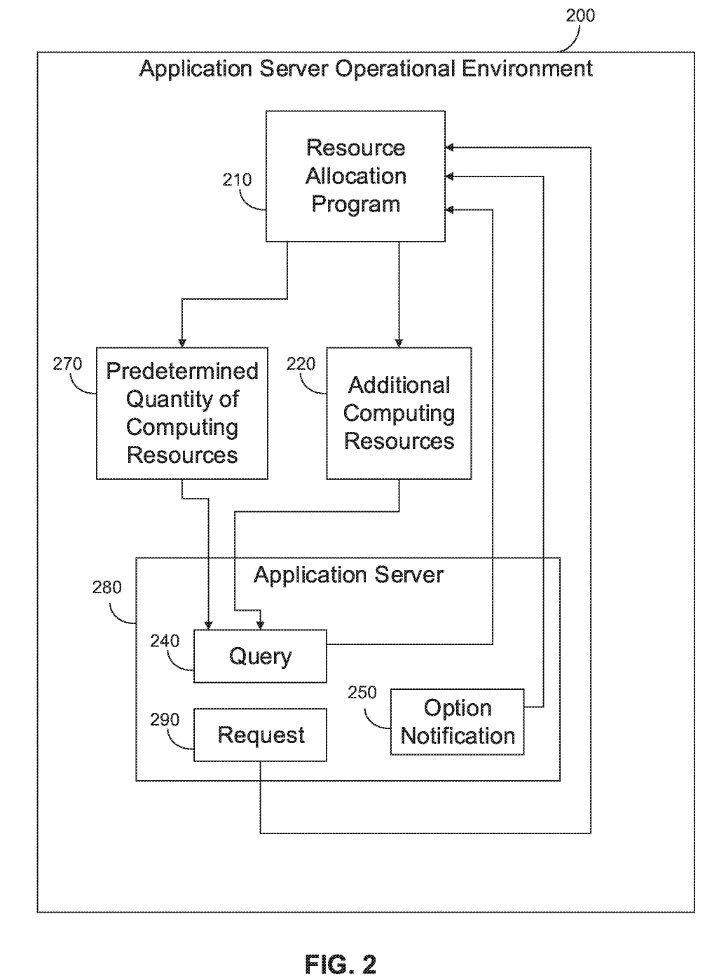

FIG. 2 is a block diagram of an application server operational environment suitable for operation of a resource allocation program via an application server, in accordance with at least one embodiment of the present invention. In an embodiment, an application server operational environment 200 includes a resource allocation program 210, a predetermined quantity of computing resources 270, an additional computing resources 220, an application server 280, a query 240, a request 290, and an option notification 250, all in mutual communication and interconnected via the application server operational environment 200. The application server operational environment 200 may be a cloud-based, virtual, or distributed environment or a remote environment on defined server hardware, or, more generally, the application server operational environment 200 may be any type of environment suitable for access by the resource allocation program 210. The predetermined quantity of computing resources 270 and the additional computing resources 220 are an amount of computing resources, similar to the predetermined quantity of computing resources 170 and the quantity of running resources 120.

The application server 280 is a software framework that provides both facilities to create web applications and a server environment to run them. The application server 280 includes the query 240, the request 290, and the option notification 250. The query 240 is a query similar to the query 140.

The resource allocation program 210 allocates the predetermined quantity of computing resources 270 to the query 240. The predetermined quantity of computing resources 270 are predetermined similar to the predetermined quantity of computing resources 170. The request 290 may be a command, query, instruction, or set of instructions capable of being received, understood, and processed by the resource allocation program 210. The resource allocation program 210 may receive the request 290 from the application server 280. The request 290 may include instructions for the resource allocation program 210 to allocate the additional computing resources 220 to the query 240. The additional computing resources 220 may be determined by the resource allocation program 210. The additional computing resources 220 are an amount of computing resources. The request 290 may quantify the amount of computing resources in its instructions. The additional computing resources 220 may be understood as the mathematical difference between the amount of resources required to process the query 240 at a particular speed, such as the speed threshold 130, and the predetermined quantity of computing resources 270.

The option notification 250 may be an alert, or indication capable of being received and understood by the resource allocation program 210. In an embodiment, the resource allocation program 210 receives the option notification 250 from the application server 280. The option notification 250 may include an indication that a user responded to a request for input, such as the option 150. The option notification 250 may also include information regarding how a user responded to the request for input.

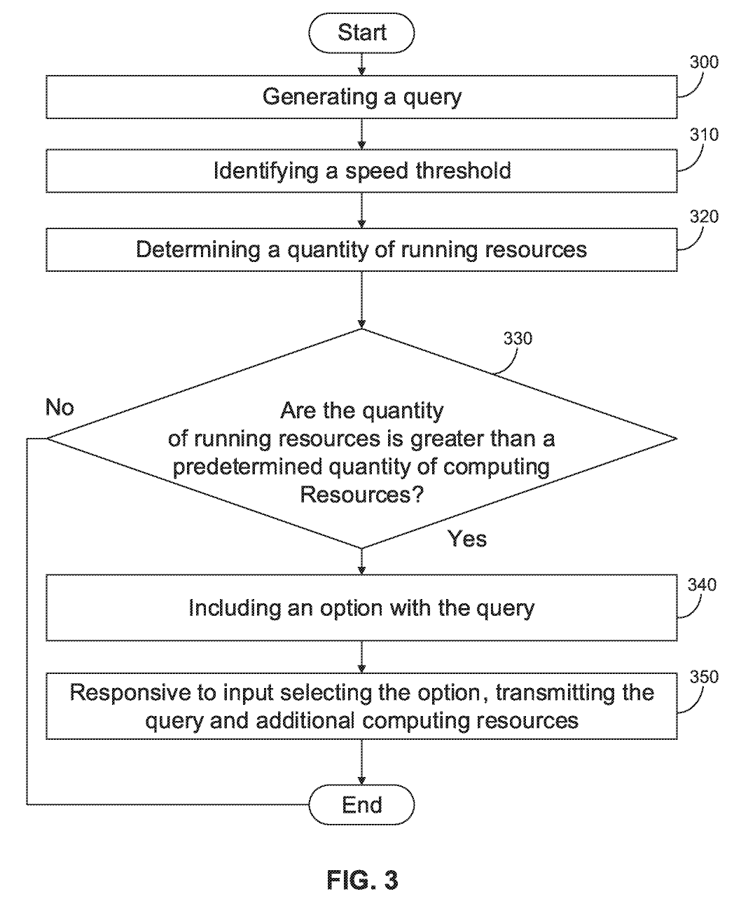

FIG. 3 is a flowchart depicting the operational steps of the resource allocation program 110, executing within the operational environment 100 of FIG. 1, in accordance with an embodiment of the present invention.

At step 300, the resource allocation program 110 generates the query 140. The resource allocation program 110 may generate the query 140 responsive to a computer application or computer program instructions, such as instructions to request data from the database server 160. The query 140 may be directed to the database server 160, which allocates the predetermined quantity of computing resources 170 to the query 140.

At step 310, the resource allocation program 110 identifies the speed threshold 130. Identifying may include a user explicitly calling the resource allocation program 110 from a command line interface using a reference to the speed threshold 130 as an argument. Alternatively, receiving may include automated calls to the resource allocation program 110, for example, from an integrated development environment or as part of a resource allocation program management system.

At 320, the resource allocation program 110 determines the quantity of running resources 120 that the query 140 would require such that its running speed exceeds the speed threshold 130 identified at step 310. Determining the quantity of running resources 120 may include analyzing the query 140, evaluating the steps included with the query 140, and estimating how much memory space is necessary for the query 140 to be processed at a speed greater than the speed threshold 130. In some embodiments, the quantity of running resources 120 may be based on a predetermined formula or other heuristic. In other embodiments, the resource allocation program 110 may estimate a quantity of computing resources required based on previous queries that were similar to the query 140.

At step 330, the resource allocation program 110 determines whether the quantity of running resources 120 is greater than or equal to the predetermined quantity of computing resources 170. Determining may include identifying the algebraic difference between the quantity of running resources 120 and the predetermined quantity of computing resources 170 and identifying whether the difference is positive. In such an example, if the differences is positive, the quantity of running resources 120 is greater than the predetermined quantity of computing resources 170. If the quantity of running resources 120 is greater than the predetermined quantity of computing resources 170, the resource allocation program 110 proceeds to step 340.

At step 340, the resource allocation program 110 includes the option 150 with the query 140. Including the option 150 with the query 140 may include updating the query 140 such that the query 140 also includes a prompt for a user to respond to, such as the option 150.

At step 350, the resource allocation program 110 responds to user input selecting the option 150 by transmitting the query 140 and additional computing resources 220. The additional computing resources 220 are an amount of computing resources, similar to the predetermined quantity of computing resources 170 and the quantity of running resources 120. The additional computing resources 220 are an amount of computing resources equal to the mathematical difference between the quantity of running resources 120 and the predetermined quantity of computing resources 170.

In some embodiments, the resource allocation program 110 may receive an update from the database server 160. The update may identify to the resource allocation program 110 that the query 140 has been processed and include resource usage information for the query 140. The update may indicate if the query 140 was processed using all of the computing resources allocated to it, or if the query 140 used fewer computing resources. If the query 140 used fewer computing resources, the resource allocation program may generate a return request, which would provide instructions capable of being understood by the database server 160. The return request may include instructions for the database server 160 to return additional computing resources 220 or any unused resources. In such an embodiment, the resource allocation program 110 may transmit the return request to the database server 160.

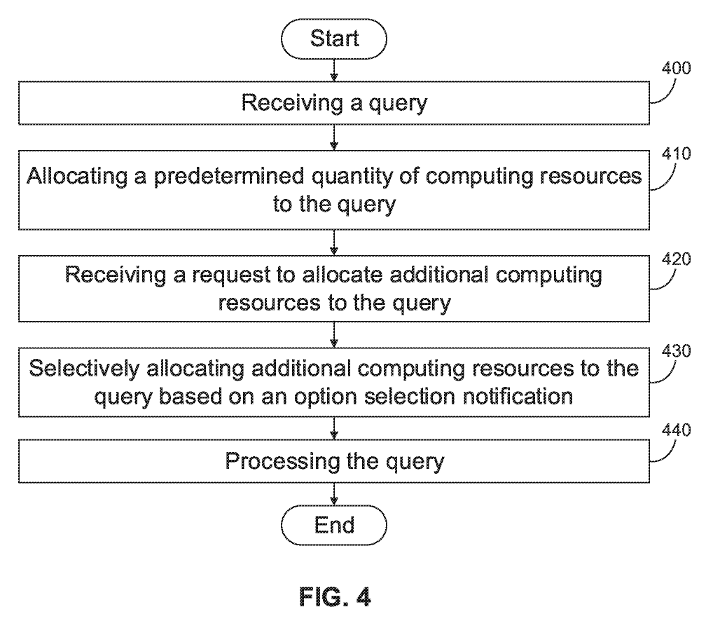

FIG. 4 is a flowchart depicting the operational steps of the resource allocation program 210, executing within the application server operational environment 200 of FIG. 2, in accordance with an embodiment of the present invention.

At step 400, the resource allocation program 210 receives the query 240 from the application server 280. Receiving may include a user explicitly calling the resource allocation program 210 from a command line interface using a reference to the query 240 as an argument. Alternatively, receiving may include automated calls to the resource allocation program 210, for example, from an integrated development environment or as part of a resource allocation program management system.

At step 410, the resource allocation program 210 allocates the predetermined quantity of computing resources 270 to the query 240. The resource allocation program 210 may allocate the predetermined quantity of computing resources 270 to the query 240 by lifting restrictions, overriding restrictions, updating instructions associated with the query 240, and/or making additional physical machines available to the query 240.

At step 420, the resource allocation program 210 receives the request 290 from the application server 280. The request 290 may be a request to allocate additional computing resources, such as the additional computing resources 220, to the query 240.

At step 430, the resource allocation program 210 selectively allocates the additional computing resources 220 to the query 240, based on the resource allocation program 210 receiving the option notification 250. The resource allocation program 210 may be responsive to receiving the option notification 250. The resource allocation program 210 may respond by allocating the additional computing resources 220 to the query 240.

At step 440, the resource allocation program 210 processes the query 240. Processing the query 240 includes using the predetermined quantity of computing resources 270 and the additional computing resources 220.

In some embodiments, the additional computing resources 220 are available via a platform as a service. In such an embodiment, the resource allocation program 210 may generate an update. The update may identify that the query 240 has been processed and include information regarding the quantity of computing resources the query 240 used while being processed. The update may include if the query 240 was processed using fewer resources than were allocated to the query 240, and may further indicate a quantity of unused computing resources. The resource allocation program 210 may then return the additional computing resources 220 or unused computing resources to the service as a platform.

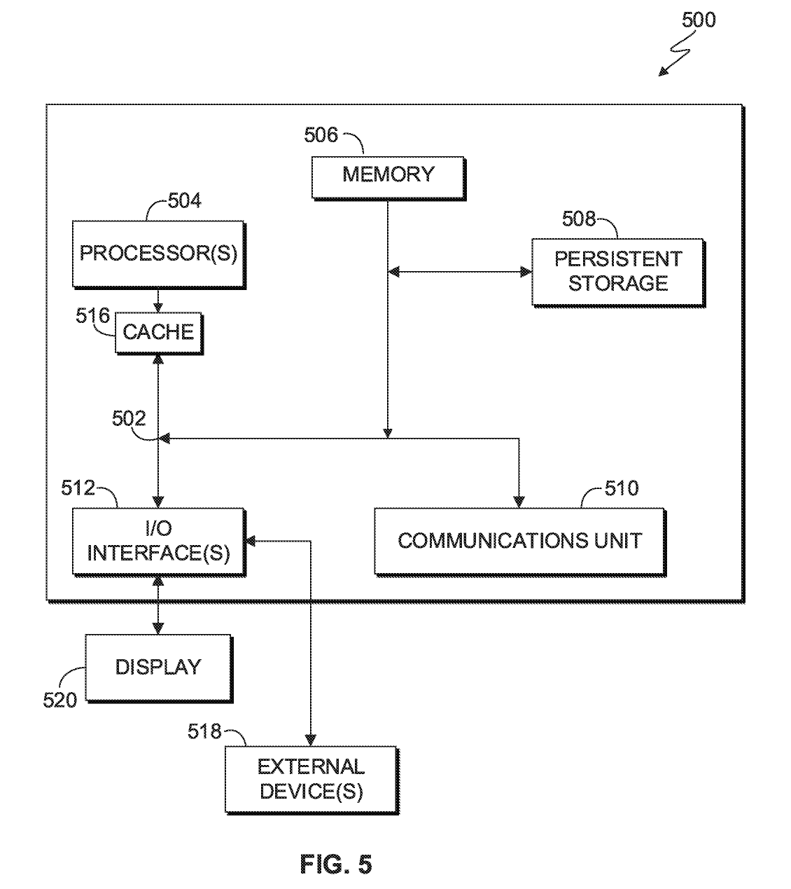

FIG. 5 is a block diagram depicting components of a computer 500 suitable for executing the resource allocation program 110 and the resource allocation program 210. FIG. 5 displays the computer 500, the one or more processor(s) 504 (including one or more computer processors), the communications fabric 502, the memory 506, the RAM 516, the cache 516, the persistent storage 508, the communications unit 510, the I/O interfaces 512, the display 520, and the external devices 518. It should be appreciated that FIG. 5 provides only an illustration of one embodiment and does not imply any limitations with regard to the environments in which different embodiments may be implemented. Many modifications to the depicted environment may be made.

As depicted, the computer 500 operates over a communications fabric 502, which provides communications between the cache 516, the computer processor(s) 504, the memory 506, the persistent storage 508, the communications unit 510, and the input/output (I/O) interface(s) 512. The communications fabric 502 may be implemented with any architecture suitable for passing data and/or control information between the processors 504 (e.g., microprocessors, communications processors, and network processors, etc.), the memory 506, the external devices 518, and any other hardware components within a system. For example, the communications fabric 502 may be implemented with one or more buses or a crossbar switch.

The memory 506 and persistent storage 508 are computer readable storage media. In the depicted embodiment, the memory 506 includes a random access memory (RAM). In general, the memory 506 may include any suitable volatile or non-volatile implementations of one or more computer readable storage media. The cache 516 is a fast memory that enhances the performance of computer processor(s) 504 by holding recently accessed data, and data near accessed data, from memory 506.

Program instructions for the resource allocation program 110 and the resource allocation program 210 may be stored in the persistent storage 508 or in memory 506, or more generally, any computer readable storage media, for execution by one or more of the respective computer processors 504 via the cache 516. The persistent storage 508 may include a magnetic hard disk drive. Alternatively, or in addition to a magnetic hard disk drive, the persistent storage 508 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of the persistent storage 508.

The communications unit 510, in these examples, provides for communications with other data processing systems or devices. In these examples, the communications unit 510 may include one or more network interface cards. The communications unit 510 may provide communications through the use of either or both physical and wireless communications links. The resource allocation program 110 and the resource allocation program 210 may be downloaded to the persistent storage 508 through the communications unit 510. In the context of some embodiments of the present invention, the source of the various input data may be physically remote to the computer 500 such that the input data may be received and the output similarly transmitted via the communications unit 510.

The I/O interface(s) 512 allows for input and output of data with other devices that may operate in conjunction with the computer 500. For example, the I/O interface 512 may provide a connection to the external devices 518, which may include a keyboard, keypad, a touch screen, and/or some other suitable input devices. External devices 518 may also include portable computer readable storage media, for example, thumb drives, portable optical or magnetic disks, and memory cards. Software and data used to practice embodiments of the present invention may be stored on such portable computer readable storage media and may be loaded onto the persistent storage 508 via the I/O interface(s) 512. The I/O interface(s) 512 may similarly connect to a display 520. The display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and resource allocation program 96.

What is claimed is:

1. A computer-implemented method comprising:
generating a query, said query being directed to a database server, said database server allocating a predetermined quantity of computing resources to said query;
identifying a speed threshold;
determining a quantity of running resources, said quantity of running resources being effective for a running speed for said query to exceed said speed threshold;
responsive to said quantity of running resources being greater than said predetermined quantity of computing resources:
including an option with said query, said option being for additional computing resources to be allocated to said query; and
responsive to input selecting said option, transmitting said query and said additional computing resources to said database server.

2. The computer-implemented method of claim 1, wherein said option is expressed using a structured query language statement.

3. The computer-implemented method of claim 1, wherein said computing resources are available to said database server via a cloud environment.

4. The computer-implemented method of claim 3, wherein said cloud environment is a platform as a service.

5. The computer-implemented method of claim 1, further comprising:
receiving an update from said database server, said update identifying that said query has been processed, said update including resource usage information for said query, said update including a quantity of unused computing resources;
generating a return request, said return request being to return said unused computing resources; and
transmitting said return request to said database server.

6. A computer-implemented method comprising:
receiving, from an application server, a query;
allocating a predetermined quantity of computing resources to said query;
receiving, from said application server, a request to allocate additional computing resources to said query;
selectively allocating said additional computing resources to said query based on an option selection notification, said option selection notification being from said application server; and
processing said query.

7. The computer-implemented method of claim 6, wherein said additional computing resources are available via a platform as a service.

8. The computer-implemented method of claim 6, further comprising:
generating an update, said update identifying that said query has been processed, and said update including resource usage information for said query;
identifying, based on said resource usage information for said query, a quantity of unused computing resources; and
returning said unused computing resources to said platform as a service.

9. A computer program product comprising:
one or more computer readable storage media and program instructions stored on said one or more computer readable storage media, said program instructions comprising instructions to:
generate a query, said query being directed to a database server, said database server allocating a predetermined quantity of computing resources to said query;
identify a speed threshold;
determine a quantity of running resources, said quantity of running resources being effective for a running speed for said query to exceed said speed threshold;
responsive to said quantity of running resources being greater than said predetermined quantity of computing resources:
include an option with said query, said option being for additional computing resources to be allocated to said query; and
responsive to input selecting said option, transmit said query and said additional computing resources to said database server.

10. The computer program product of claim 9, wherein said option is expressed using a structured query language statement.

11. The computer program product of claim 10, wherein said computing resources are available to said database server via a cloud environment.

12. The computer program product of claim 11, wherein said cloud environment is a platform as a service.

13. The computer program product of claim 9, further comprising instructions to:
receive an update from said database server, said update identifying that said query has been processed, said update including resource usage information for said query, said update including a quantity of unused computing resources;
generate a return request, said return request being to return said unused computing resources; and
transmit said return request to said database server.
